(19) United States
(12) Patent Application Publication
(10) Pub. No.: US 2010/0224621 A1
(43) Pub. Date: Sep. 9, 2010

(54) Method and Means for Controlling Power Delivery to an Equipment for Counter-Acting Formation of Ice or for Removing Snow/Ice on a Constructional Element

(75) Inventor: Kjell Mortensen, Tromso (NO)

Correspondence Address: WENDEROTH, LIND & PONACK, L.L.P., 1030 15th Street, N.W.,, Suite 400 East, Washington, DC, 20005-1503, US

(73) Assignee: NORSK MILJØKRAFT FORSKNING OG UTVIKLING AS, Tromso (NO)

(21) Appl. No.: 12/227,142

(22) PCT Filed: May 7, 2007
(86) PCT No.: PCT/NO2007/000159

§ 371 Date: Sep. 25, 2009

(30) Foreign Application Priority Data
May 8, 2006 (NO) 2006 2052

(51) Int. Cl. H05B 1/02

(52) U.S. Cl. 219/490

(57) ABSTRACT

In order to remove snow or ice from an exposed constructional element (1) by means of electric current in a heat emission equipment (3), the supply of power is controlled by way of a controller (13) operating based on physical parameter values as measured by sensors (4, 14, 15, 17, 18, 19) at the constructional element (1) and based on historical data relating to snow and ice conditions. The input data are the effective surface temperature of the constructional element (1) as well as the amount of snow/ice on the constructional element (1), air temperature, wind velocity, precipitation, velocity of the constructional element (1), and vibrations thereof. These input data are compared to stored historical data in the controller (13). The controller (13) then calculates, using stored algorithms, whether the supply of power is necessary, and in that case also the necessary amperage and frequency values, the frequency affecting a time constant of change in the surface temperature of the constructional element. The controller then provides a start or stop signal as well as an output control signal to power supply equipment (11), and the controller then updates its historical data with new data. Preferably, the invention is used on the blades of a wind turbine.

### INTRODUCTION

The present invention relates to a method and means for controlling the supply of electrical power for preventing the formation of ice or for removing snow/ice from a constructional element. In practice, its primary application will be for removing or preventing the formation of layers of snow or ice on a wind turbine wing, although the invention will also find application for aeroplane wings, chopper rotors, and in particular moveable, but also stationary outdoor constructional elements at exposed locations, such as oil installations in arctic regions.

### TECHNOLOGICAL BACKGROUND

Today, there is a strong global desire to utilize energy sources that do not represent a risk to the environment. In this respect, a potential exploitation of the energy associated with the wind presents a very interesting solution. Thus, there has been a strong worldwide growth in the use of wind power as a source for the production of environmentally friendly energy.

A large portion of the available wind power resources are located in areas in which the climate represents a problem for the operation of wind turbines due to the formation of ice or snow layers on essential components of the turbines. This problem requires shut-down of the turbines, increasing the costs and reducing the earnings associated with the installation, thus taking away the viability of investing in wind power generation. Hence, a significant energy potential may remain unexploited.

Today, some methods exist for handling the problem of ice and snow layer formation on wind turbines. However, these methods are both costly as well as technically complicated, and increase the costs associated with both construction and operation of the installation.

U.S. Pat. No. 6,612,810 discloses a wind turbine wherein a thin metal foil is arranged in the turbine wings. An electric current may be passed through the metal foil, hence acting as a heating element and being able to melt any ice or snow present on the wing. The metal foil may be laminated into the wing surface, or may be fixed thereto using glue, for example. The patent also refers to heating control using a relay connected to an ice sensor located on the wing surface. Hence, the sensor controls an on-off, i.e. not adjustable, supply of current to the metal foil from a power supply. This is a very simple manner of control that has turned out to be inadequate due to high power consumption. In addition, water from melting ice will flow to non-heated areas and re-glaciate.

European Patent EP-0-983.437-B1 also discloses heating of wind turbine wings. In this patent, fabrics including electrically conductive fibers, arranged on the outside of or inside the wing surface, are used as heating elements to remove snow or ice. The current to the heating elements can be controlled by a temperature/power controller measuring and monitoring a number of parameters, such as the weather conditions in the proximity of the turbine and the surface temperature of the wing, among others. Also, the controller may control the distribution of current to the different heating elements according to predetermined procedures for deicing parts of the wings in order to avoid imbalance when sheets of ice fall off the wings, for example. A control model is used that involves, inter alia, feedback for modifying the function based on ambient operating conditions. Accordingly, however, this concerns the function of distributing current to different spots on the wings.

U.S. Pat. No. 5,344,696 discloses a heating system for aeroplane wings, including layers of electrically conductive material laminated into the wing. In this system, the current supplied to the heating elements has a frequency in the range of 50-400 Hz. The system also uses a control system based on temperature sensors in the wing and the surface thereof, connected to a microprocessor controller. The voltage may be adjusted based on the temperatures measured. This is still a simple control system that is not able to account for empirical data.

Finally, the earlier Norwegian patent application no. 20042395 of the applicant discloses a heating system for wind turbine wings applying high frequency electric current to metal foils on the wing surfaces. In this application, an adaptive, automatic controller is used that collects data from sensors sensing climate conditions, that is, air temperature, wind velocity and precipitation. In addition, data relating to wing surface temperature in areas of the wing that are exposed to snow and ice, as well as data from rotational speed and vibration sensors, are collected. The controller determines the amperage and frequency based on data from the sensors as well as historical data relating to snow and ice conditions for the turbine in question, in order to control a frequency transformer to achieve an optimum supply of power to the metal foils on the wings.

The latter publication is considered to be the closest prior art. However, the applicant has realized that this technology can be improved as an unresolved problem remains in the control methodology, namely the fact that still too much power is consumed for deicing.

### SUMMARY OF THE INVENTION

The control method to which the present invention relates represents a solution to the above problem, as the method provides for a higher level of energy efficiency. Nonetheless, the method is still simple to use from a technical perspective and represents a favorable solution in terms of cost. The method is also simple and inexpensive to use during operation of a wind turbine.

Thus, according to the invention a method is provided for controlling the supply of electrical power by way of high frequency alternating current from an equipment for supplying power to a heating equipment for preventing the formation of ice or for removing ice or snow from a constructional element, wherein the control is effected using a controller based on input data representing physical parameter values as measured by sensors arranged at or nearby the constructional elements, as well as based on stored, historical data relating to snow and ice conditions for the constructional element, providing an adaptive manner of control. The method according to the invention is characterized in that
current input data relating to the value of the effective surface temperature of the constructional element and to values of the following parameters: the amount of snow/ice on the constructional element, air temperature, wind velocity, precipitation, velocity of the constructional element, and vibrations of the constructional element, is compared, in the controller, to stored data relating to historical values of the same parameters, recorded as a function of time, and
using stored algorithms, the controller calculates, based on said relevant input and historical data, whether delivery of power is required, and in that case also the amperage and frequency values necessary to remove snow/ice from the constructional element, the frequency affecting a time constant of change in the surface temperature of the constructional element,
according to the result of the calculation, the controller then issues a start or stop signal as well as an output control signal including amperage and frequency values to the power supply equipment, and
the controller updates its historical data with new parameter value data resulting from a current condition of snow/ice on the constructional element according to a predetermined procedure.

Moreover, in a supplementary aspect of the invention, a means is provided for controlling the supply of electrical power by way of high frequency alternating current from an equipment for supplying power to a heating equipment for preventing the formation of ice or for removing ice or snow from a constructional element, comprising a controller operating based on input data representing physical parameter values as measured by sensors arranged at or nearby the constructional element, and based on stored, historical data relating to snow and ice conditions for the constructional element, wherein the controller is of the adaptive type. The means according to the invention is characterized in
that the controller is configured for comparing current input data relating to the value of effective surface temperature for the constructional element and to values of the following parameters: the amount of snow/ice on the constructional element, air temperature, wind velocity, precipitation, velocity of the constructional element, and vibrations of the constructional element, to stored data relating to historical values of the same parameters, recorded as a function of time, and
that the controller is further configured for computing, using stored algorithms and based on said relevant input and historical data, whether delivery of power to the heating equipment is required, and in that case also the amperage and frequency values necessary to remove snow/ice from the constructional element, the frequency affecting a time constant of change in the surface temperature of the constructional element,
that the controller is further configured to, according to the result of said calculation, issue a start or stop signal as well as an output control signal including amperage and frequency values to the power supply equipment, and
that the controller is configured to update its historical data with new parameter value data resulting from a current condition of snow/ice on the constructional element, according to a predetermined procedure.

The method and means described herein provide a technically and economically favorable deicing for preventing the build-up of snow or formation of ice on essential components of wind turbines installed in areas having climatic conditions representing a risk of icing.

By way of this method, one will achieve an optimum exploitation of the existing power production potential at any given time, and thereby help enabling more geographical areas to be put in use for a profitable production of environmentally friendly wind power, also in a global perspective.

With the method according to the invention, wind turbines may be kept in operation also when critical combinations of temperature, wind, and precipitation cause the build-up of snow or formation of ice on the rotating elements of the turbine, or on elements on which icing may cause unacceptable static loads.

The method has a significant commercial potential given the strong growth in the development of wind power facilities. Additionally, a great portion of the geographical regions having a significant wind power potential is located in areas in which the climatic conditions cause the build-up of snow or formation of ice on essential components of the turbine.

The method will handle most problems associated with snow or ice on wind turbines in an efficient and economically favorable manner. Moreover, it will also facilitate an increased value creation within the industry, as, among other things, it yields an increased return on the investments necessary in areas involving a risk of snow or icing.

### BRIEF DESCRIPTION OF THE DRAWINGS

In the following, a more detailed description of the invention will be given, including a detailed review of advantageous embodiments thereof, with reference to the attached drawings, in which

FIG. 1 shows a section through a part of a constructional element, in particular a wind turbine wing, with metal foil applied for heating,

FIG. 2 shows a schematic of the controller used for adjusting the supply of electrical power to the metal foils, and

FIG. 3 is a block diagram showing the control method according to an embodiment of the invention.

### DETAILED DESCRIPTION OF EMBODIMENTS OF THE INVENTION

Initially, it should be noted that while the description is based on wind turbines from which ice must be removed, the invention also will find application in other areas, such as for aeroplane wings, chopper rotors, and other outdoor structures, in particular moveable structures, for example, so reference is made generally to a “structure” and a “constructional element” when the invention is set forth in its most general form. Even so, in the following wind turbines will be referred to as practical embodiments.

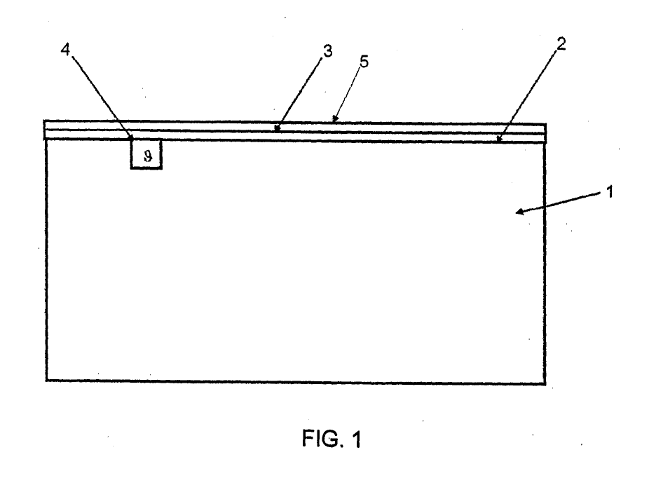

As mentioned above, and referring to FIG. 1, the method according to the present invention relates to the use of high frequency electric current for heating the surface 2 of the elements 1 that are subject to snow or ice in an amount that is not acceptable during operation of the turbine. The surface 2 of element 1 on which the layering of snow or formation of ice cannot be allowed, is provided with an electrically conducting material 3, preferably constituted by a metal foil, being continuous or in the form of varying width stripes, adhered to the surface 2 as a tape. The tape will also provide the necessary protection of surface 2 against mechanical and chemical stresses. The foil may be fixed to surface 2 by a fastener allowing the foil to be removed for or during maintenance. Through the conductive material 3 (foil) is passed a high frequency current as dictated by the on-site climatic data, as provided by the system to which the method relates. The equipment makes sure that current is passed through the material 3 of surface 2 when there is a risk that snow or ice may appear on the essential elements to be protected. With that, the temperature of surface 2 rises, preventing the build-up of snow or formation of ice. Likewise, on start-up of a wind turbine after an inactive period, removal of snow or ice on essential components will be effected before the turbine is started.

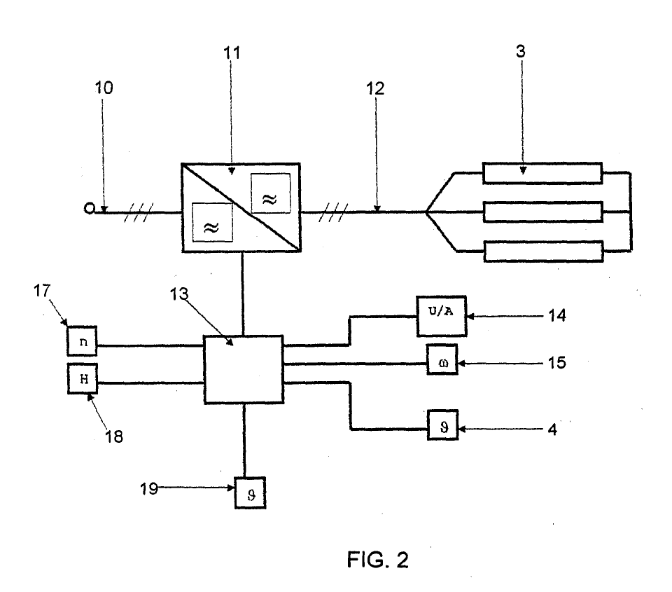

Referring next to FIG. 2, the device according to the invention is mainly comprised of equipment 11, 13 for the adaptive generation of high frequency current having variable amperage and frequency. Power to the equipment may be taken from the generator of the turbine or from the power grid 10 to which the turbine feeds the generated power. The equipment further comprise a controller 13 for controlling, monitoring, and inspecting the technological components of the overall system, including sensors 4, 14, 15, 17, 18, 19 necessary for continuously detecting mechanical and climatic conditions at the location of the turbine.

The start-up and operation of the system is automatic, based on data regarding the climatic conditions at the location and governed by the operating conditions at the installation, taking into account whether the turbine is running or if start-up is being prepared.

The adaptive, automatic controller 13 collects data from sensors sensing climatic conditions, including air temperature 19, wind velocity 17, and precipitation 18. Additionally, data are collected from the elements of the turbine that may be subject to snow or icing, i.e. from surface temperature sensor 4, rotational velocity sensor 15, and vibration sensor 14. Based on data from the sensors and historical data relating to snow and ice conditions for the turbine in question, controller 13 determines the amperage and frequency for the high frequency current to be fed to metal foil (heating elements) 3, and adjusts a frequency transformer 11 for optimizing the supply of power to metal foil 3.

Controller 13 continuously monitors the presence of snow or ice on the exposed parts as seen in relation to the climatic data and operating data, and uses such data in the continuous calculation of the amperage and frequency to be fed to heating elements 3.

Through foil 3 is passed a high frequency current having a frequency causing the current to flow mainly in the surface layer of the foil. The frequency of the current is adjusted by the system so as to minimize the consumption of power in the system, based, inter alia, on the surface temperature of the element on which to prevent the build-up of snow or formation of ice. The optimum frequency is calculated using algorithms based on current and historical data. As a matter of fact, the frequency of the heating current influences a time constant of change in the surface temperature of the element, so it is possible to find a frequency that in a “cheapest possible” manner leads to a rapid heating. The surface temperature time constant is affected, inter alia, by the relation between frequency and current displacement in the heating element.

The system for preventing the formation of ice and/or snow layers on the structure starts and stops automatically, governed by information from sensors sensing the on-site climatic and mechanical conditions, based on that the current temperature, precipitation, and wind velocity, together with the general operational conditions (rotational velocity of the turbine, vibrations, surface temperature), indicate that snow or ice may layer on essential components, in view of the climatic conditions, topography, as well as the geographical location at which the turbine is installed.

Controller 13 also allows for adaptive adjustment of the operation of the heat emission equipment (metal foil) 3 based on empirical data regarding snow and ice related problems for the turbine at which the unit is installed.

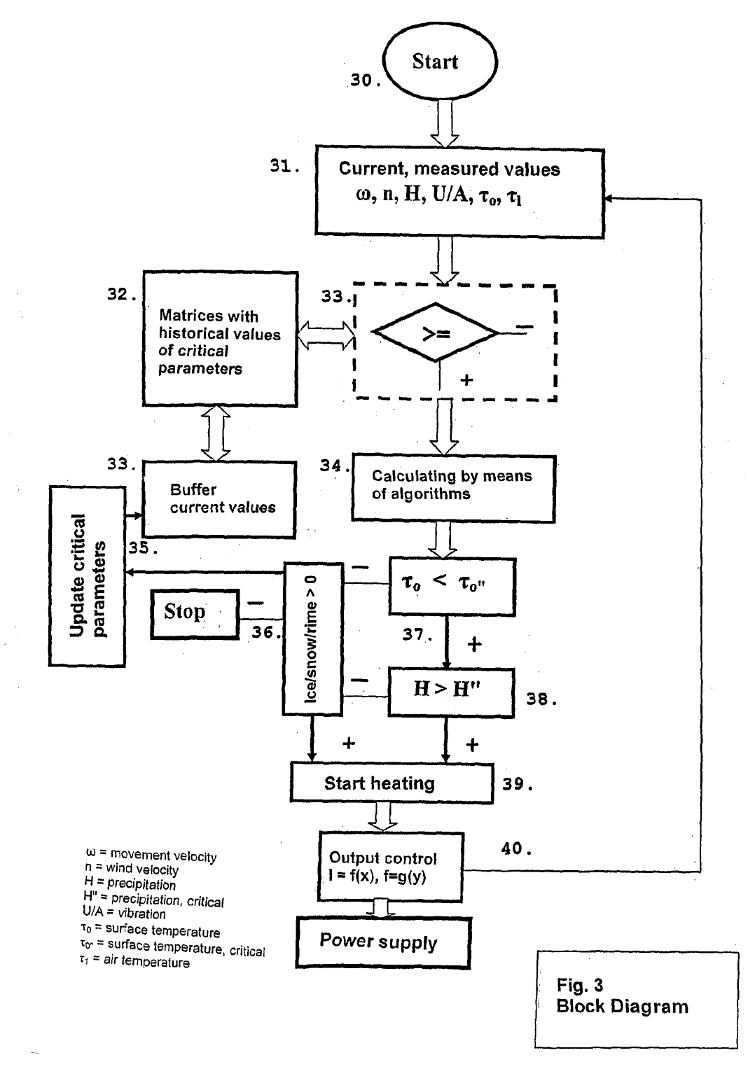

Reference is now made to FIG. 3, which is a block diagram of the control methodology according to which controller 13 operates. The algorithm starts at 30. In block 31, incoming data for relevant, measured parameters are detected, such as value of the wind turbine velocity, ω, wind velocity, n, precipitation, H (sensor), vibrations of the turbine wings, U/A, as well as surface temperature, τ₀, of the wings and air temperature, τ₁.

In block 32, all historical values of critical parameters are stored. The values are automatically updated when a change of a particular critical value is detected. This is performed when the current value buffered in block 33 is determined to be different from the one stored in block 32. This happens when it is identified as an updated critical value in block 35.

In block 33, the current values are compared to the critical values. When a current parameter value is greater than or equal to the critical value of the parameter, a signal is issued to calculate an appropriate action in block 34. Otherwise, no action is initiated.

Based on the calculation in block 34 and on a comparison of the surface temperature to the critical surface temperature value in block 37, and on a comparison of current precipitation to critical precipitation (amount of rime/ice/snow/water) in block 38, if the current values exceed the critical values, a signal will be issued to initiate heating in block 39 and calculation of the output (current and frequency) for the heating equipment in block 40.

If the sensors detect ice/snow/rime in block 36, even if the current precipitation and temperature values do not exceed critical values, then critical values are updated in block 35.

If the temperature and precipitation values do not exceed the critical values, and the sensors also do not detect precipitation, the equipment goes to halt.

By way of the above procedure, an optimum output of the power necessary for preventing/removing ice/snow is provided for through an adaptive control that automatically adjusts to the particular climate at the location of use. In this manner, the power consumption is reduced to the absolute minimum for each particular installation.

1. A method for controlling the supply of electrical power by way of high frequency alternating current from an equipment (11) for supplying power to a heat emission equipment (3) for preventing the formation of ice or for removing ice or snow from a constructional element (1), wherein the control is effected using a controller (13) based on input data representing physical parameter values as measured by sensors (4, 14, 15, 17, 18, 19) arranged at or nearby the constructional elements (1), as well as based on stored, historical data relating to snow and ice conditions for the constructional element (1), providing an adaptive manner of control, characterized in that
current input data relating to the value of the effective surface temperature of the constructional element (1) and to values of the following parameters: the amount of snow/ice on the constructional element (1), air temperature, wind velocity, precipitation, velocity of the constructional element (1), and vibrations of the constructional element (1), is compared, in the controller (13), to stored data relating to historical values of the same parameters, recorded as a function of time, and
using stored algorithms, the controller (13) calculates, based on said relevant input and historical data, whether delivery of power is required, and in that case also the amperage and frequency values necessary to remove snow/ice from the constructional element (1), the frequency affecting a time constant of change in the surface temperature of the constructional element (1),
according to the result of the calculation, the controller (13) then issues a start or stop signal as well as an output control signal including amperage and frequency values to the power supply equipment (11), and
the controller (13) updates its historical data with new parameter value data resulting from a current condition of snow/ice on the constructional element (1) according to a predetermined procedure.

2. The method of claim 1, characterized in that the frequency used is in the range of 0-1000 kHz.

3. The method of claim 1, characterized in that the predetermined procedure for updating the historical data includes all pertinent parameters for detecting and preventing/removing ice/snow from the structure.

4. A means for controlling the supply of electrical power by way of high frequency alternating current from an equipment (11) for supplying power to a heat emission equipment (3) for preventing the formation of ice or for removing ice or snow from a constructional element (1), comprising a controller (13) operating based on input data representing physical parameter values as measured by sensors (4, 14, 15, 17, 18, 19) arranged at or nearby the constructional element (1), and based on stored, historical data relating to snow and ice conditions for the constructional element (1), whereby the controller (13) is of the adaptive type, characterized in
that the controller (1) is configured for comparing current input data relating to the value of effective surface temperature for the constructional element (1) and to values of the following parameters: the amount of snow/ice on the constructional element (1), air temperature, wind velocity, precipitation, velocity of the constructional element (1), and vibrations of the constructional element (1), to stored data relating to historical values of the same parameters, recorded as a function of time, and
that the controller (13) is further configured for computing, using stored algorithms and based on said relevant input and historical data, whether delivery of power to the heat emission equipment (3) is required, and in that case also the amperage and frequency values necessary to remove snow/ice from the constructional element (1), the frequency affecting a time constant of change in the surface temperature of the constructional element (1),
that the controller (13) is further configured to, according to the result of said calculation, issue a start or stop signal as well as an output control signal including amperage and frequency values to the power supply equipment (11), and
that the controller is configured to update its historical data with new parameter value data resulting from a current condition of snow/ice on the constructional element, according to a predetermined procedure.

5. The means of claim 1, characterized in that the means is configured for controlling the supply of electrical power to an electrically conductive foil on at least a wing of a wind turbine.

6. The means of claim 4, characterized in that the power supply equipment is formed by an adjustable frequency transformer receiving power from an external power grid (10).
